(19) United States
(12) Patent Application Publication
(10) Pub. No.: US 2022/0134272 A1
(43) Pub. Date: May 5, 2022

(54) COMPACT VENTURI SCRUBBER AND METHOD TO TREAT GAS STREAMS UTILIZING THE COMPACT VENTURI SCRUBBER

(71) Applicant: Norton Engineering Consultants, Inc., Fairfield, NJ (US)

(72) Inventors: James P. Norton, Ridgewood, NJ (US); Richard S. Todd, Bloomfield, NJ (US)

(21) Appl. No.: 17/513,211

(22) Filed: Oct. 28, 2021

Related U.S. Application Data
(60) Provisional application No. 63/107,933, filed on Oct. 30, 2020.

(51) Int. Cl. B01D 47/10; B01D 47/06

(52) U.S. Cl. CPC B01D 47/10; B01D 47/06

(57) ABSTRACT

Disclosed is a compact venturi scrubber, used for removing undesirable materials from a gas stream, that includes a gas inlet section, a discharge section aligned with the gas inlet section, the discharge section having a base defined by the intersection of the gas inlet section and the discharge section, a diverging interior surface, and a diverging angle defined by the diverging interior surface, a nozzle, and a liquid inlet through which a liquid scrubbing medium is introduced to the nozzle, wherein the nozzle produces a full spray pattern directed towards the base of the discharge section with a sufficiently large discharge angle so that a cross-sectional area of the full spray pattern produced by the nozzle at the point it intersects with the base of the discharge section fully covers, and substantially matches the size and shape of, the cross-sectional area of the base of the discharge section.

### CROSS REFERENCES TO RELATED APPLICATIONS

This application claims the benefit of U.S. Provisional Patent Application No. 63/107,933 filed on Oct. 30, 2020. The disclosure and entire teachings of U.S. Provisional Patent Application 63/107,933 are hereby incorporated by reference.

### FIELD OF THE INVENTION

The field of the present invention relates to the use of wet scrubbing systems to treat gas streams for removal of materials, including such materials as contaminants, residual reactants, and catalysts.

### BACKGROUND

Wet scrubbing systems are employed to treat gas streams for undesirable materials removal via interception, absorption, adsorption, chemical reaction or any combination ofthese processes by contacting said gas streams with a scrubbing liquid stream whose composition and conditions are suitable for the specific gas being treated and the overall treatment objectives. The gas-liquid contacting necessary for treatment of a gas stream isa function of the inlet gas stream condition and composition, the desired effluent gas condition and composition, the scrubbing liquid condition and composition, and the means employed to physically contact the liquid and gas streams. Devices and methods for liquid-gas contacting are common in many industries with equipment available from many suppliers and ranging from simple systems employing enclosures with one or more layers of liquid sprays to high energy consumption venturi systems capable of achieving very high material concentration reductions. The method and apparatus of an embodiment of the present invention provides a more efficient means of venturi liquid-gas contacting than currently practiced yielding benefits in improved performance, improved operating flexibility, improved inspection and maintenance capability, improved mechanical reliability, reduced plot space, and lower energy consumption.

Wet scrubbing systems employing conventional ejector venturis for liquid-gas contacting use either a small number of large venturis, installed outside the main gas enclosure, or a large number of small venturis, installed inside the gas enclosure, to achieve the intimate liquid-gas contacting necessary for high contaminant removal efficiencies.

Systems employing a small number of large venturis are configured as single stage systems and cannot be readily reconfigured to provide multiple high efficiency low pressure drop venturi scrubbing stages due to the size of the venturi scrubbers. These systems require more inlet flue gas ducting as compared to an embodiment of the present invention to move the inlet gas to the typically higher elevation of the large, appended venturi inlets and individual ducting to each venturi inlet. Scrubbing systems employing the compact venturi scrubbers described herein typically require a single gas inlet at a significantly lower elevation simplifying inlet gas ducting. The economic employment of multiple venturi stages in systems employing the compact venturi scrubbers described herein allows each stage to operate at lower energy and different scrubbing liquid composition resulting in lower energy consumption for equivalent scrubber performance as compared to single stage systems.

Systems employing a large number of small venturis are readily configured as one of a number of stages in multi-stage systems, the number of venturi scrubbing stages being limited by the back pressure each venturi scrubbing stage exerts on the inlet gas, and require inlet circulating liquid piping and nozzles to be installed inside the gas enclosure where they cannot be accessed for maintenance or for performance improvement with the scrubbing system on-stream. The method and apparatus of an embodiment of the present invention addresses the limitations of conventional small venturi based wet scrubbing systems by providing the compact venturi scrubber described hereinwith improved scrubbing performance and good pressure recovery characteristics, which can be installed inside the gas enclosure while providing access to circulating liquid piping and nozzles from outside the gas enclosure allowing on-stream maintenance or replacement of the liquid nozzle(s) thereby improving unit reliability. The capability for on-stream nozzle replacement also allows the performance of unit to be modified without needing to shut down the scrubber (replacement of liquid nozzles with nozzles of alternate designs). Multiple venturi scrubbing stages can be included in scrubbing system designs employing the compact venturi scrubber described herein without exerting excessive back pressure on the inlet gas stream due to the low gas side pressure drop characteristics of the compact venturi scrubber described herein. The ability to add additional venturi scrubbing stages reduces the overall energy required to meet any specified scrubber performance criteria. Scrubbing systems employing the compact venturi scrubber described herein have fewer venturi scrubbers and specialty liquid nozzles in each contacting stage reducing the number of specialty equipment and the amount of circulating liquid piping reducing both capital and maintenance (spare parts) costs.

### SUMMARY

Method and apparatus for the removal of undesirable materials from gas streams (gas treatment) produced by manufacturing processes, combustion of hydrocarbon fuels and incineration/thermal oxidation of solids, liquid and gaseous wastes by means of wet scrubbing are disclosed. An embodiment of the present invention makes several improvements over conventional wet scrubbing systems including: a compact venturi scrubber, which allows for design of compact multi-unit, multi-stage scrubbers to achieve high scrubbing efficiencies; and a compact venturi scrubber which uses the progressively variable area of the discharge section for contacting and collection of undesirable materials.

An embodiment of the present invention provides a compact venturi scrubber including: a gas inlet section, a discharge section aligned with the gas inlet section, the discharge section having (i) a base defined by the intersection of the gas inlet section and the discharge section, (ii) a diverging interior surface, and (iii) a diverging angle defined by the diverging interior surface, a nozzle, and a liquid inlet through which a liquid scrubbing medium is introduced to the nozzle, wherein the nozzle produces a full spray pattern directed towards the base of the discharge section with a sufficiently large discharge angle so that a cross-sectional area of the full spray pattern produced by the nozzle at the point it intersects with the base of the discharge section fully covers, and substantially matches the size and shape of, the cross-sectional area of the base of the discharge section.

An embodiment of the present invention provides a venturi scrubbing system including one or more scrubbing stages, each scrubbing stage having one or more compact venturi scrubbers, each compact venturi scrubbers including: a gas inlet section, a discharge section aligned with the gas inlet section, the discharge section having (i) a base defined by the intersection of the gas inlet section and the discharge section, (ii) a diverging interior surface, and (iii) a diverging angle defined by the diverging interior surface, a nozzle, and a liquid inlet through which a liquid scrubbing medium is introduced to the nozzle, wherein the nozzle produces a full spray pattern directed towards the base of the discharge section with a sufficiently large discharge angle so that a cross-sectional area of the full spray pattern produced by the nozzle at the point it intersects with the base of the discharge section fully covers, and substantially matches the size and shape of, the cross-sectional area of the base of the discharge section.

An embodiment of the present invention provides a method for the removal of materials from a gas stream utilizing a compact venturi scrubber that includes a gas inlet section, a discharge section aligned with the gas inlet section, the discharge section having (i) a base defined by the intersection of the gas inlet section and the discharge section, (ii) a diverging interior surface, and (iii) a diverging angle defined by the diverging interior surface, a nozzle, and a liquid inlet through which a liquid scrubbing medium is introduced to the nozzle, the method including: producing, by the nozzle, a full spray pattern directed towards the base of the discharge section with a sufficiently large discharge angle so that the cross-sectional area of the full spray pattern produced by the nozzle at the point it intersects with the base of the discharge section fully covers, and substantially matches the size and shape of, the cross-sectional area of the base of the discharge section, and passing the gas stream through the gas inlet section and discharge section of the compact venturi scrubber as it mixes with the liquid scrubbing medium.

### BRIEF DESCRIPTION OF THE DRAWINGS

FIG. 1A is a depiction of the compact venturi scrubber.

FIG. 1B is a depiction of the compact venturi scrubber installation.

FIG. 2 is a depiction of an isolation assembly.

FIG. 3 is a cross sectional view of a two-stage venturi scrubbing system which uses the compact venturi scrubber in both scrubbing stages.

FIGS. 4A and 4B depict various orientations of the compact venturi scrubber in the first scrubbing stage in the two-stage venturi scrubbing system depicted in FIG. 3.

FIGS. 5A, 5B and 5C depict various orientations of the compact venturi scrubber in the second stage of the two-stage venturi scrubbing system depicted in FIG. 3.

FIG. 6 depicts a two-stage compact venturi scrubber system with an inter-stage gas treatment section.

FIG. 7 depicts a conventional ejector venturi scrubber.

FIG. 7A depicts a conventional ejector venturi scrubbing system.

FIG. 8 depicts a conventional venturi scrubber which can be installed internal to a gas enclosure.

FIG. 8A depicts a conventional two-stage scrubbing system comprised of a first spray scrubbing stage followed by a second venturi scrubbing stage.

FIG. 8B depicts a conventional two-stage scrubbing system comprised of a first packed bed or grid scrubbing stage followed by a second venturi scrubbing stage.

FIG. 8C depicts a conventional two-stage scrubbing system comprised of a first tray scrubbing stage followed by a second venturi scrubbing stage.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

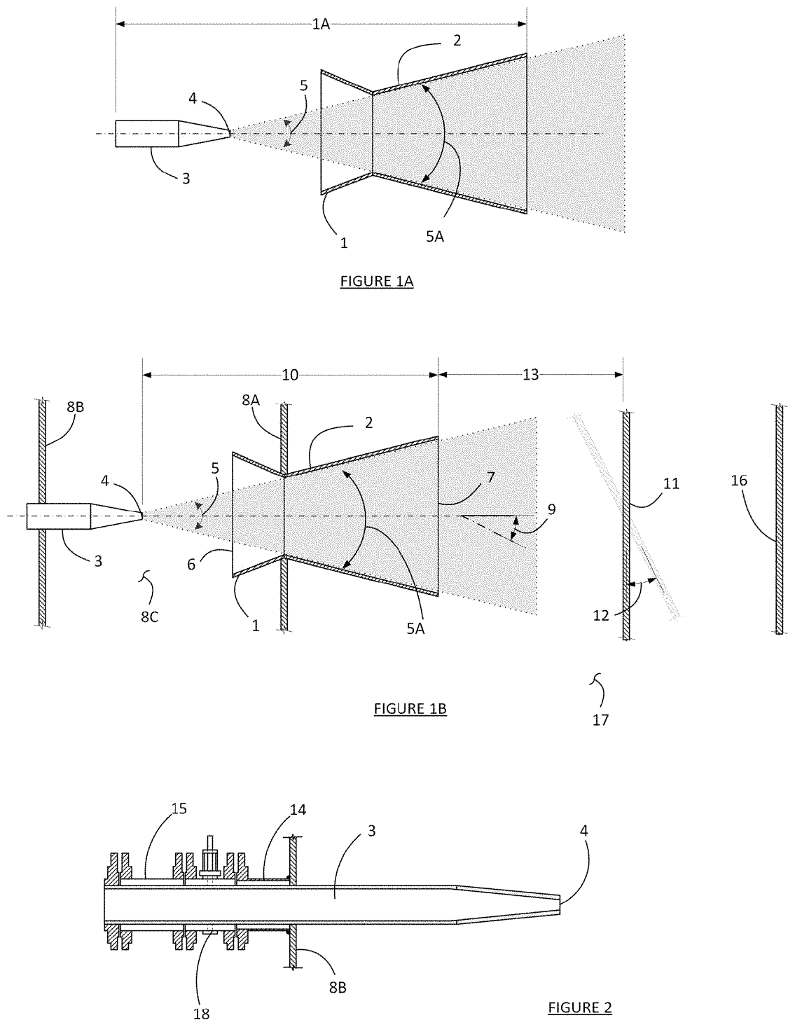

FIG. 1A shows the compact venturi scrubber (1A) described herein. The compact venturi scrubber is comprised of a converging gas inlet section (1), a diverging discharge section (2) aligned with the gas inlet section (1), a liquid inlet (3) and a nozzle (4). A liquid scrubbing medium is introduced to nozzle (4) through the liquid inlet (3). The nozzle (4) is located a sufficient distance from the base of the discharge section (2) (the base of the discharge section (2) being the cross sectional area defined by the intersection of the discharge section (2) and the gas inlet section (1)) and is designed to produce a full spray with a sufficiently large discharge angle (5) so that the cross sectional area of the spray pattern produced by the nozzle (4) at the point it intersects with the base of the discharge section (2) fully covers the cross sectional area of the base of the discharge section (2). Full coverage of the base of the discharge section (2) by the spray pattern produced by the nozzle (4) ensures that no gas bypasses the base of the discharge section (2) without contacting the scrubbing liquid. In a preferred embodiment of the present invention, the cross sectional geometry and area of the spray pattern at the point it reaches the base of the discharge section (2) will match the cross-sectional geometry and area of the base of the discharge section (2), and the cross-sectional geometry of the discharge section (2) itself, thereby minimizing any impact of the liquid spray on the interior surface of the gas inlet section (1) and the discharge section (2), resulting in maximum liquid scrubbing medium for scrubbing downstream of the base of the discharge section (2). In a preferred embodiment of the present invention the geometries of the cross-sectional areas of the spray pattern, the base of the discharge section (2), and the discharge section (2) are the same and are either circular or rectangular. This maximizes liquid coverage throughout the discharge section (2) as the gas and liquid transits the discharge section (2), enabling more liquid to be available for continuous scrubbing resulting in reduced energy consumption for a specified level of performance or improved unit performance at the same energy level as conventional systems. When necessary, multiple nozzles (4) can be used to generate the desired spray pattern. The discharge section (2) may be designed with the same diverging angle, the diverging angle of the discharge section being defined by the diverging interior surface of the discharge section) as the spray discharge angle (5) from the nozzle (4), thereby minimizing any impact of the liquid scrubbing medium on the interior surface of the discharge section (2), maximizing liquid scrubbing medium for scrubbing. While the diverging angle of the discharge section in conventional ejector venturi scrubbers is typically less than 15 degrees and most often less than 10 degrees, the diverging angle of the discharge section (2) of an embodiment of the present invention may be greater than 20 degrees and in a preferred embodiment of the present invention 20 to 45 degrees, resulting in the length of the compact venturi scrubber (1A) being less than 25% of the length of a conventional venturi scrubber of equivalent capacity.

The nozzle (4) is designed to atomize scrubbing liquid into first sheets and then into small droplets which provide surface area for absorption of gaseous species and interception of small particulate material and fumes, while simultaneously providing fast moving targets for the collection of larger solid particulate and fumes via inertial impaction. The nozzle (4) may be designed to provide droplets of varying sizes, velocities, and dispersion patterns necessary to accomplish removal of undesirable materials from the gas stream. The scrubbing liquid partially mixes with the gas flowing co-currently through the gas inlet section (1) to the discharge section (2) where both inlet gas and scrubbing liquid are intimately mixed/dispersed. The angle formed by the interior surface of the gas inlet section (1) is sufficiently large so as not to block any portion of the scrubbing liquid spray from reaching the point where the gas inlet section (1) attaches to the discharge section (2). Dependent on design requirements, the angle formed by the interior surface of the gas inlet section (1) may be as large as 180 degrees.

As depicted in FIG. 1B, gas to be treated enters the gas inlet section (1) of one or more compact venturi scrubber(s) from a plenum (8C) formed by an inner wall (8A) and an outer wall (8B) or alternatively from a duct or other gas enclosure (e.g., duct, pipe, vessel, tank, reactor, drum, etc.). The gas to be treated is accelerated as it passes through the gas inlet section (1) reaching its highest velocity at the point where the gas inlet section (1) attaches to the discharge section (2).

The combined gas and liquid stream enters the discharge section (2) uniformly mixed. At the base of the discharge section (2) there is differential velocity between the scrubbing liquid stream (sheets and droplets) and gas. This differential velocity is critical to scrubber performance and also provides energy to the gas stream to offset some or all of the venturi gas side pressure losses. To maximize differential velocity between the liquid stream and the gas, and to maximize the availability of scrubbing liquid for treatment of the gas, the discharge section (2) is designed with the same diverging angle (5A) as the spray discharge angle (5) from the nozzle (4). Thus, as the gas passes through the discharge section (2) its velocity decreases as the cross-sectional area of the discharge section (2) increases. The higher momentum liquid stream continues to disperse with minimal impact on the interior surface of the discharge section (2). Sheets and ligaments of scrubbing liquid continue to disintegrate through the entire length (10) of the compact venturi scrubber, maximizing droplet formation and enhancing gas treatment capability. The velocity difference between the gas and the liquid stream gradually increases in the discharge section (2) further enhancing gas treatment capability.

As depicted in FIG. 1B, the combined gas and liquid stream is discharged from the compact venturi scrubber through the discharge section outlet (7) into a treated gas chamber (17) enclosed by walls (16). When small droplets are necessary to achieve the required level of gas treatment additional gas liquid separation devices (11) may be required downstream of the discharge section outlet (7). These devices can take many forms from simple perpendicular target plates, located a fixed distance (13) from the venturi discharge (7), to more complex inlet vapor horns available commercially. The compact venturi scrubber can be rotated to provide partial or full impact on enclosure walls (16) to minimize chamber internals. The orientation of a compact venturi scrubber or a group of compact venturi scrubbers can also be changed (9) as another means for improving liquid separation.

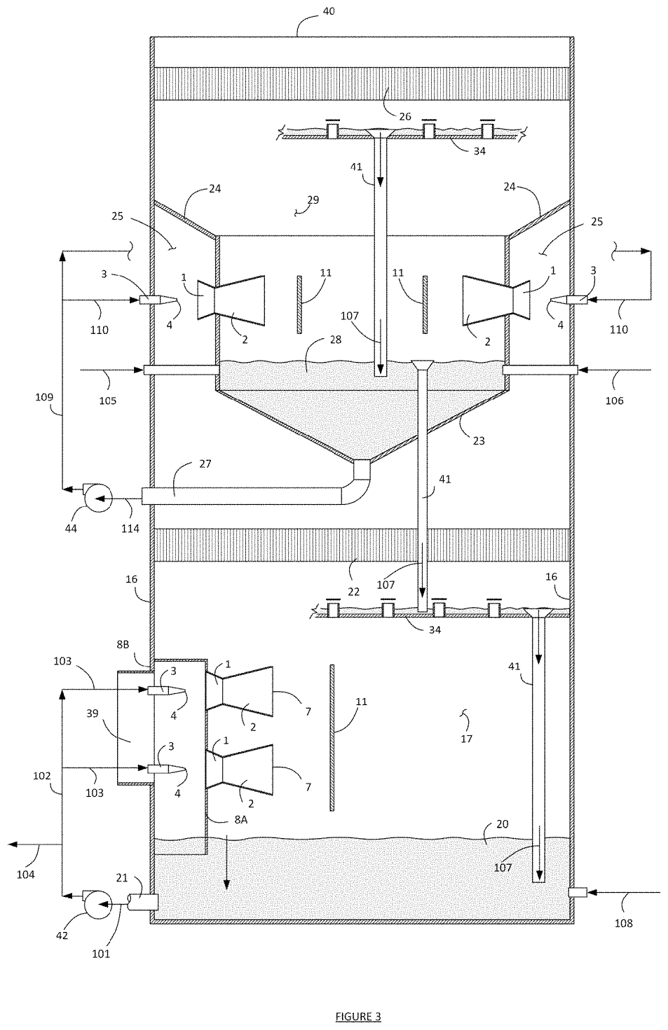

The compact nature of an embodiment of the present invention allows installation of the compact venturi scrubber(s) inside a gas enclosure while providing access to the liquid inlet (3) and nozzle (4) from outside the gas enclosure. An isolation assembly, such as shown in FIG. 2, can be used to prevent leakage of gas when the liquid inlet 3 and the nozzle 4 are removed. The isolation assembly may be comprised of a mounting nozzle (14), an isolation valve (18) and a packing gland (15). The incorporation of an isolation assembly enables the liquid inlet (3) and the nozzle (4) to be maintained or replaced with the scrubbing system in service, thereby maximizing overall unit reliability and runlength. In addition, this feature allows nozzles of differing design to be installed to change the performance characteristics of the scrubber without taking the scrubber out of service.

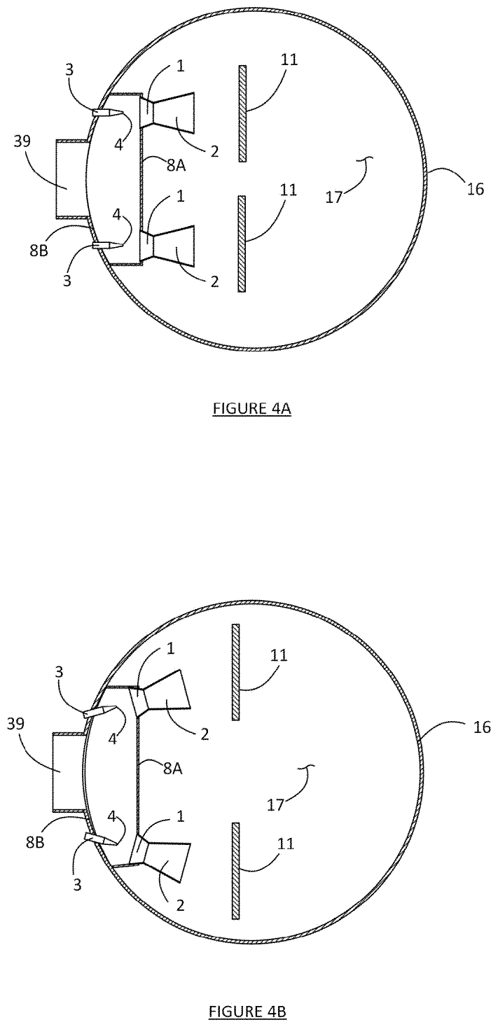

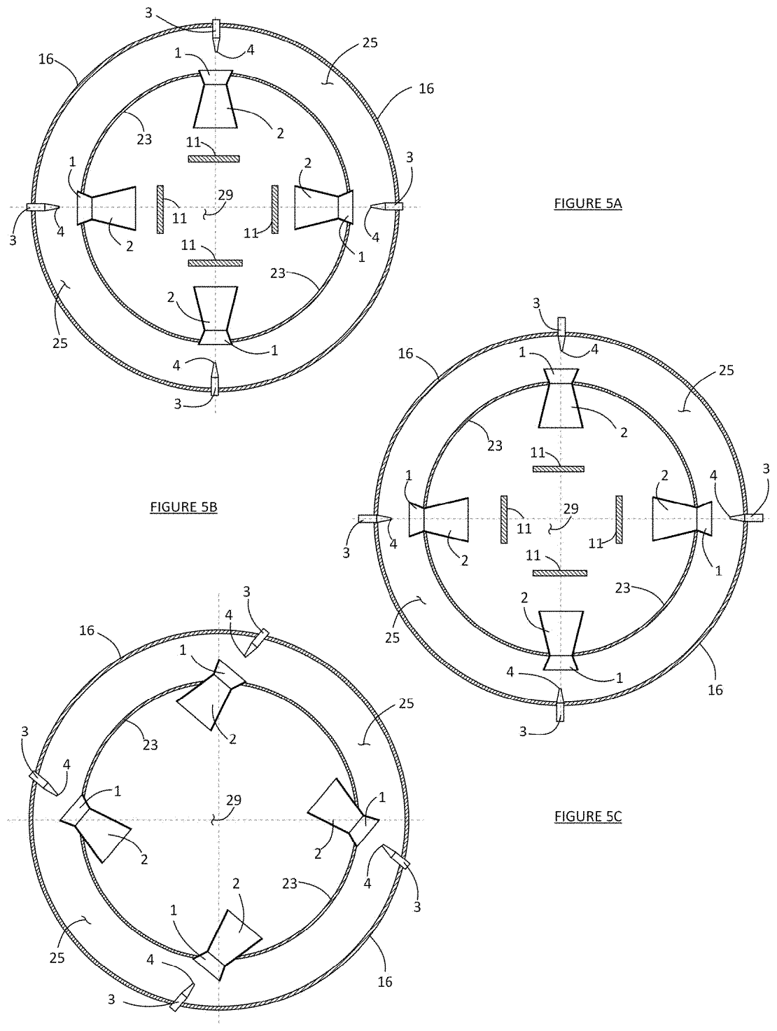

An embodiment of the present invention enables the economic employment of multiple stage scrubbing systems. FIG. 3 shows a two-stage scrubbing system incorporating the compact venturi scrubbers (1A) described herein. The two-stage scrubbing system consists of an enclosure defined by wall (16) having one or more gas inlets (39) which direct the inlet gas stream to the plenum (8C) bounded by outer wall (8B) and inner wall (8A), with inner wall (8A) segregating the inlet gas stream from the treated gas stream exiting the discharge section outlet(s) (7). The gas in the inlet chamber must flow through one or more compact venturi scrubbers prior to being discharged into a first treated gas chamber (17). The two-phase, liquid and gas, mixture exits one or more discharge section outlet(s) (7) and passes into the first treated gas chamber (17). The compact venturi scrubber can discharge directly into the first treated gas chamber (17) for primary liquid/vapor separation or can be directed to make contact with a liquid separation device (11) or to make contact with the chamber walls (16) or can be directed towards or through any other impingement device or surface to increase droplet impaction, as depicted in FIGS. 4A and 4B, to reduce the amount of entrained liquid droplets in the treated gas stream carried overhead to a de-entrainment device (22) located at the outlet of the first treated gas chamber (17).

The lower portion of the first treated gas chamber (17) may be designed to provide a sump for collection and storage of first stage scrubbing liquid inventory (20). First stage scrubbing liquid from the sump (20) is supplied to one or more first stage circulation pump(s) (42) via liquid outlet nozzle (21) and pump suction line (101). The circulation pumps (42) provide the required scrubbing liquid flow and pressure to the first stage compact venturi scrubber(s) through a main supply line (102) and branch lines (103) to each liquid inlet (3). The liquid sump (20) volume is set based on design criteria for sump level control and to provide sufficient inventory to allow continued scrubber operation during high inlet gas contaminant loading.

Treated gas in the first stage treated gas chamber (17) is saturated with the scrubbing liquid and carries a small amount of liquid droplets to the de-entrainment device (22). This device can be any one of a number of commercially available de-entrainment devices for liquid/vapor separation. The selection of the particular de-entrainment device is dependent on the allowable amount of first stage scrubbing liquid which can be added to the second stage scrubbing liquid without compromising second stage performance or reliability. The collected droplets coalesce into larger droplets and liquid films which fall back into the liquid sump (20) under the influence of gravity. Depending on specific design requirements, a full draw tray (34), as depicted partially in FIG. 3, may be provided to reduce the liquid loading to the de-entrainment device (22) by minimizing the potential re-entrainment of droplets as they fall through the turbulent gas flow patterns in the first stage treated gas chamber (17).

After reducing the amount of entrained liquid to an acceptable level, the treated gas flows into a region (25) defined by an outer wall (16 or 8B) and an inner wall (8A), the inner wall (8A) being comprised of the side wall (23) of the second stage liquid sump (28) and the wall (24) separating region (25) and the second stage treated gas chamber (29). One or more compact venturi scrubber(s) are installed penetrating the inner wall (8A) providing a passage for gas to flow from region (25) to the second stage treated gas chamber (29). As gas flows through the second stage compact venturi scrubber(s) it is again contacted with a scrubbing liquid stream for additional treatment. The design specifications for the compact venturi scrubbers used in stage one and stage two do not need to be the same.

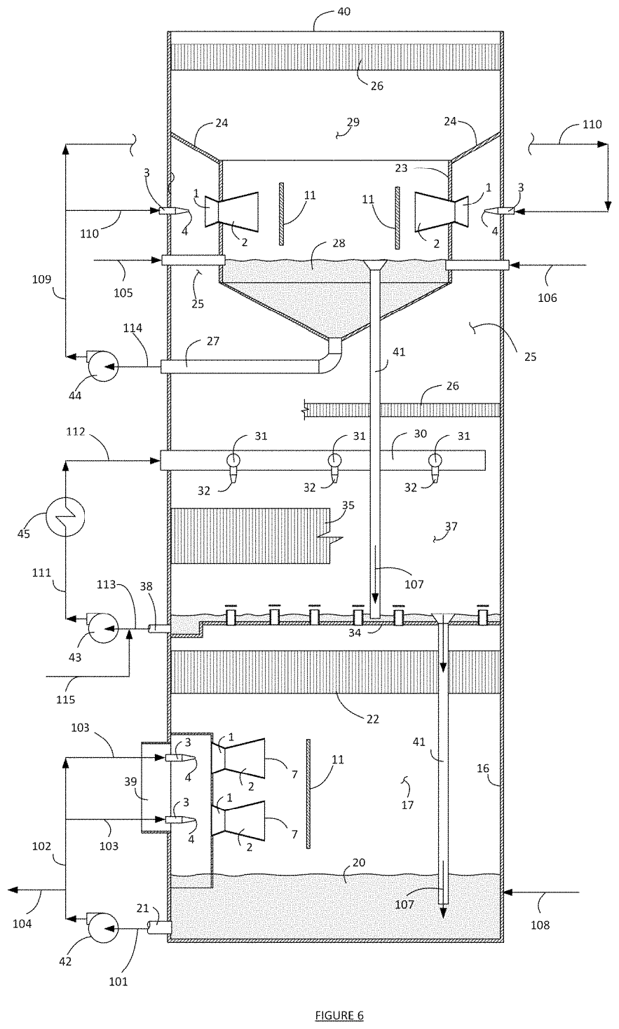

In the second scrubbing stage, treated gas and liquid discharged from discharge section outlet(s) (7) can be directed to impact liquid separation devices (11) or the side walls (23) of the second stage liquid sump (28), can be directed downward towards the surface of the second stage liquid sump (28), or provided another means for initial droplet removal. Various compact venturi scrubber discharge orientations are depicted in FIGS. 5A, 5B and 5C.

Scrubbing liquid is directed or flows by gravity into the second stage sump (28) where it is collected and stored for use in the second scrubbing stage. Second stage scrubbing liquid is fed to one or more second stage circulation pump(s) (44) via liquid outlet nozzle (27) and pump suction line (114). The circulation pump(s) (44) provide the required scrubbing liquid flow and pressure to the second stage liquid inlet(s) (3) through a main supply line (109) and branch lines (110) to each liquid inlet (3). The liquid sump (20) volume is set based on design criteria for sump level control and to provide sufficient inventory to allow continued scrubber operation during high inlet gas contaminant loading.

Treated gas from the second stage venturis carries a small amount of liquid droplets to the de-entrainment device (26). This device can be any one of a number of commercially available de-entrainment devices for liquid/vapor separation. The selection of the particular de-entrainment device is dependent on the allowable amount of undesirable materials which can be contained in exhaust gases passing out of the scrubber exit (40). The collected droplets coalesce into larger droplets and liquid films which fall back into the second stage liquid sump (28) under the influence of gravity. Depending on specific design requirements, a full draw tray (34), as depicted partially in FIG. 3, may be provided to reduce the liquid loading to the de-entrainment device (26).

When needed, make-up liquid is added to the second stage liquid sump (28) from an external source via a make-up liquid line (105). When required, a scrubbing reagent (alkalis such as ammonium, sodium and calcium hydroxides, etc., acids such as HCl, HBr, H₂SO₄, etc., reaction termination reagents such as alcohols absorbents such as amines, ionic liquids etc.) is added to the second scrubbing stage to react with undesirable materials in the treated gas from the first scrubbing stage which are absorbed into the scrubbing liquid which in turn allows additional undesirable materials to be absorbed into the scrubbing liquid. Reagent is added to the second stage liquid sump (28) from an external source via a reagent line (106). Both make-up liquid and reagent can also be added to the suction of the second stage circulation pump (44).

A continuous overflow from the second stage liquid sump (28) via overflow line (41) maintains a predetermined, fixed level in the second stage liquid sump (28). The overflow stream (107) contains second stage scrubbing liquid (which is comprised of water or other fluid, depending on the application), trace quantities of collected particulate, and absorbed and reacted gaseous contaminants which comingles with the first stage scrubbing liquid in the first stage liquid sump (20). The first scrubbing stage treats the inlet gas stream which contains the highest level of contaminants. Therefore, the first stage scrubbing liquid will have higher levels of particulate matter and absorbed and reacted gaseous contaminants than the second stage scrubbing liquid. To accommodate the higher contaminants, scrubbing reagent, when required, may be added to the first stage liquid sump (20) via a reagent feed line (108) which can introduce reagent directly to the first stage liquid sump (20) or alternatively to the suction line (101) feeding the first stage circulation pump(s) (42). Reagent addition to the first scrubbing stage is typically much greater than the amount of reagent added to the second scrubbing stage. The segregation of the circulating liquid in each of the scrubbing stages allows low reactant concentrations to be used in the second scrubbing stage which reduces the thermodynamic equilibrium concentration of contaminants in the treated gas maximizing scrubbing performance. In contrast, the higher concentration of reactants in the first stage results in higher treated gas contaminant concentrations, which are passed to the second stage scrubber where their removal can be accomplished. As an example, a gas containing 2,000 vppm (volume parts per million) SO₂ (an acid gas contaminant) is treated in the first stage of a two-stage scrubber with caustic (NaOH). The scrubbing liquid is operating at a pH of 7.0 and contains 7.5 wt % sodium salts (Na₂SO₄, Na₂SO₃ and NaHSO₃). During contact between the inlet gas and the scrubbing liquid in the first stage compact venturi scrubbers, the liquid droplets absorb SO₂, converting some of the Na₂SO₃ to NaHSO₃ resulting in a decrease in the scrubbing liquid pH. The new liquid composition has an SO₂ equilibrium vapor pressure of 0.0007 psia, equivalent to an SO₂ concentration of 50 vppm in the treated gas. Contacting in the first stage compact venturi scrubbers is not complete and contact time is limited so the system can only achieve an 80% approach to equilibrium resulting in a treated gas SO₂ concentration of 62.5 vppm. The second stage scrubbing liquid chemistry is controlled independently of the first stage by controlled make-up liquid and reagent addition. In the example case the second stage liquid is controlled to a pH of 7.3 and 2.5 wt % sodium salts. During contact between the inlet gas and the scrubbing liquid in the second stage compact venturi scrubbers, the liquid droplets absorb SO₂, converting some of the Na₂SO₃ to NaHSO₃ resulting in a decrease in the scrubbing liquid pH. Since the amount of SO₂ in the gas is much lower than the gas entering the first stage (96.9% of the inlet SO₂ has been removed in the first stage) much less Na₂SO₃ is converted to NaHSO₃ and the pH drop is proportionately lower than in the first stage. The scrubbing liquid composition exiting the second stage compact venturi scrubbers has an SO₂ equilibrium vapor pressure of 0.00007 psia, equivalent to an SO₂ concentration of 5 vppm in the treated gas. Gas—liquid contacting in the second stage compact venturi scrubbers is not complete and contact time is limited so, like the first stage, the second stage compact venturi scrubbers can only achieve an 80% approach to equilibrium resulting in a final treated gas SO₂ concentration of 6.25 vppm.

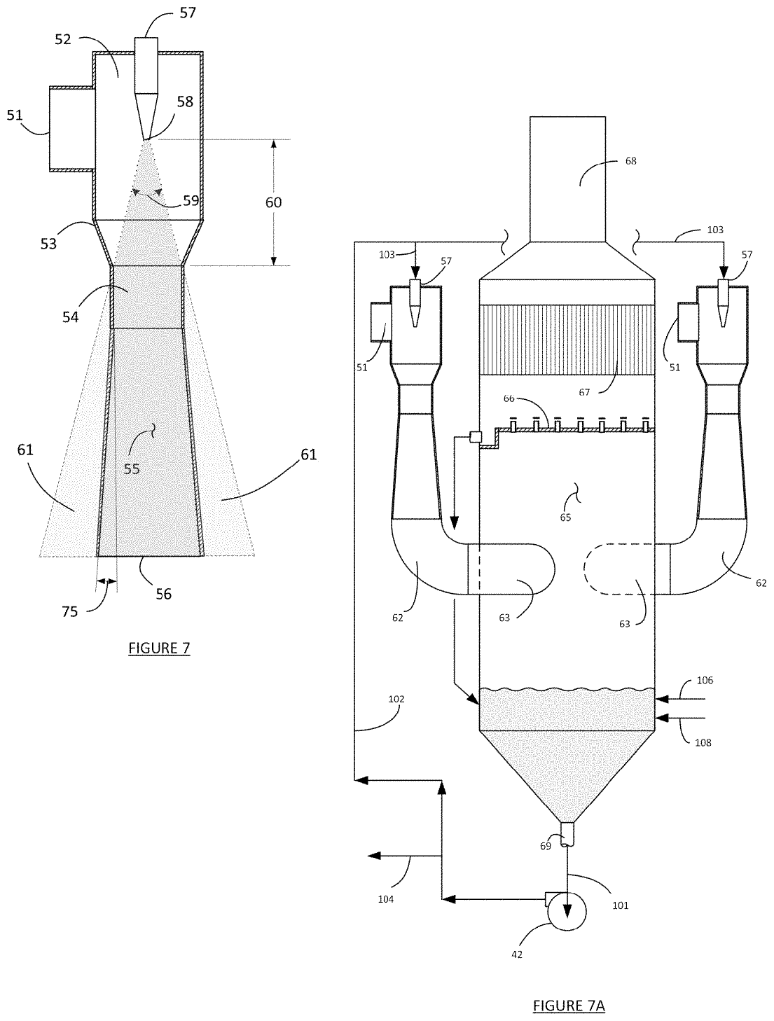

FIG. 6 depicts an embodiment of the present invention which includes a section for flue gas treatment such as cooling, absorption, chemical reaction and like processes which can take place via low energy contacting of the first stage treated gas with a circulating liquid stream. Such an inter-stage treatment section may be comprised of a full draw tray (34) which has passages for gas passage from the first stage treated gas chamber (17) to the inter-stage enclosure (37) and is used to collect and, in some cases to store, inter-stage circulating liquid, feeding same to one or more inter-stage circulation pump(s) (43) via enclosure nozzle (38) and pump suction line (115). The inter-stage liquid circulation pump(s) (43) provide the flow and pressure required for the inter-stage section. Liquid from the pump(s) (43) is sent to a liquid distribution header (30), or other liquid distribution device, which may include laterals (31) fitted with spray nozzles (32) which serve to distribute the inter-stage liquid uniformly across the cross section of the inter-stage enclosure (37). Multiple stacked spray headers (30, 31 & 32) can be installed if required to affect the desired gas treatment in the section. Likewise, packing (35) or other gas/liquid contacting medium can be used in this section to improve overall gas treatment capability. One common use of the inter-stage section is for cooling of saturated gas streams to promote condensation on small droplets, fumes and small particulate effectively increasing their size thereby making them easier to collect in the second stage venturis. This can be accomplished by the addition of a heat exchanger (45) or other method for cooling the inter-stage circulating liquid stream prior to reintroduction of said stream into the inter-stage enclosure (37) and subsequent contacting with the treated gas from the first scrubbing stage. A second common use of the inter-stage section is for conversion of nitrous oxides (NO and NO₂) to more soluble N₂O₄ and N₂O₅ via oxidation with strong oxidizing agents such as ozone, sodium chlorite or sodium hypo-chlorite. After NOx conversion, the more soluble species can be collected in the second stage venturi scrubbers via contact with an aqueous solution of sodium sulfite and additional oxidizing reagent. A third use of the inter-stage section is to remove CO₂ from a gas stream using a circulating liquid stream that contains an absorbent (amine, ionic liquid etc.). When an inter-stage gas treating section is provided the second stage scrubbing liquid may be cascaded to the inter-stage section if it is compatible with the inter-stage gas treating process. If it is incompatible with the inter-stage gas treating process, the second stage overflow will be directed to the first stage liquid sump (20). Depending on specific design requirements, a full draw tray (34), as depicted in FIG. 6, may be included in the inter-stage section to segregate the inter-stage liquid from the first stage liquid.

Interstage gas treatment with a secondary gaseous stream can be implemented using simple gas dispersion nozzles generally without the need for the facilities described in the previous paragraph for circulating liquid interstage systems.

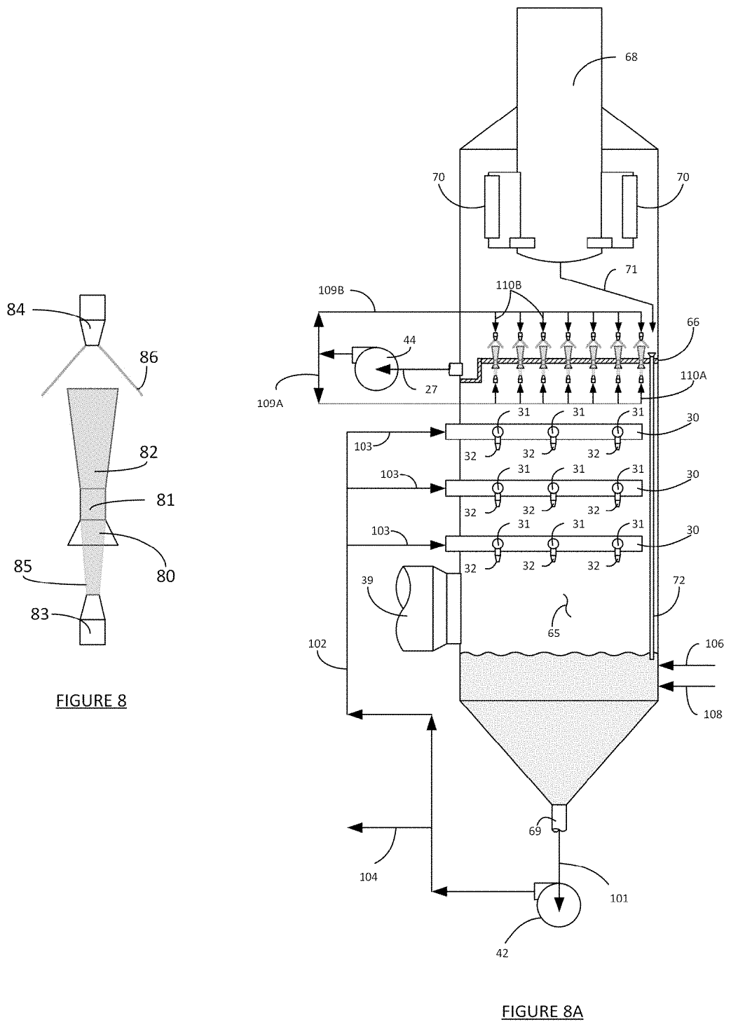

FIG. 7 depicts a conventional ejector venturi scrubber consisting of a gas inlet (51), a body (52), a converging section (53), a throat (54), a diverging section (55), an outlet (56), a liquid inlet (57) and a liquid nozzle (58) discharging a scrubbing liquid in a full cone spray pattern described by a spray angle (59). The conventional ejector venturi design places the liquid nozzle (58), discharging with spray angle (59) and a distance (60) from the top of the throat (54) such that the liquid spray pattern covers 100% of the throat cross section, intimately mixing the circulating liquid with the gas to be scrubbed. A conventional venturi is designed to remove undesirable materials from the gas stream via intimate contact in the throat (54). The mixed liquid and gas stream exiting the throat (54) enters the diverging section (55) designed to maximize pressure recovery of the gas stream and is designed with a diverging angle (75) optimized for pressure recovery. The provision of a throat (54) and a diverging section (55) designed with a diverging angle (75) to maximize gas pressure recovery causes a portion of the circulating liquid sprayed into the venturi via nozzle (58) to make contact with the ejector side walls of the throat (54) and the diverging section (55) reducing the amount of liquid droplets available to participate in the scrubbing process. The amount of liquid removed from the scrubbing process, due to this impaction is shown in FIG. 7 as the shaded region (61) can range from 25% to 40% of the total scrubbing liquid. The compact venturi scrubber (1A) is designed without a throat section and with a diverging section diverging angle (5A) equal to the spray discharge angle (5) from the nozzle (4) to minimize the amount of liquid spray impacting the diverging interior surface of the discharge section (2) maximizing the availability of liquid for scrubbing. The compact venturi scrubber (1A) is designed to achieve the required level of gas treatment in the diverging section (2) taking advantage of the increasing velocity difference between the gas and liquid streams due to the gradual reduction in gas velocity as it passes from the inlet to the outlet of the discharge section (2) and the essentially constant velocity of the liquid stream. Higher differential velocities between the liquid and vapor streams and the greater volume of liquid available for gas treatment in the compact venturi scrubber (1A) as compared to conventional ejector venturi scrubbers allows the compact venturi scrubber (1A) to achieve equivalent gas treatment performance at lower energy consumption or allows improved gas treatment performance at equivalent energy consumption when compared to conventional ejector venturis.

FIG. 7A depicts a conventional ejector venturi scrubbing system utilizing large ejector venturi scrubbers. Scrubber size typically requires venturi installation external to the gas enclosure (65) necessitating the provision of single or multiple large connection devices such as sweep elbows (62) and vessel nozzles (63) to convey the two phase gas and liquid mixture from the venturi outlet (56) to the gas enclosure (65). These devices are expensive and subject to erosion-corrosion in many applications where particulate materials are collected in the scrubber. In addition, when multiple large ejector venturi scrubbers are used, gas must be ducted to reach the venturi inlet elevation and then branch to each venturi scrubber, increasing the complexity and cost of inlet gas ducting when compared to systems with a lower elevation, single gas inlet. Treated gas and liquid exiting the enclosure nozzles (63) are partially separated, typically by contact with the enclosure (37) walls when the inlet nozzles (63) are oriented tangentially or by the use of baffle plates, or other directional change or impaction means, when oriented radially. After initial vapor liquid separation, the treated gas and some liquid droplets flow upward through the enclosure (65) and pass through a full draw tray (66) prior to entering a de-entrainment device (67) for final liquid droplet removal. After droplet removal, the treated gas is discharged through gas outlet (68). The provision of a second ejector venturi stage in the conventional large ejector venturi scrubber configuration would require building a second scrubber atop or alongside the first scrubber due to the size and orientation of the large venturis, thereby substantially increasing the cost and complexity of the system and in many cases the plot space required. A multi-stage scrubbing system using compact venturi scrubbers (1A), configured as depicted in FIGS. 3 and 6, is designed to minimize the number of gas inlets (39) thereby reducing the complexity and cost of inlet gas ducting; places the compact venturi scrubbers (1A) inside the scrubber enclosure bounded by walls (16), eliminating the external devices needed to direct the two phase liquid and gas mixture from the conventional ejector venturi outlet (56) to the gas enclosure (65) thereby saving capital investment, improving reliability and reducing maintenance costs; and incorporates multiple stages in one enclosure (16) thereby reducing plot space requirements for units requiring high gas treatment capabilities. The use of multiple smaller nozzles supported directly from the enclosure walls and readily accessible from outside the enclosure allows the provision of cost effective means for online removal enhancing scrubber reliability, reducing maintenance costs and allowing simple and effective means for changing unit performance.

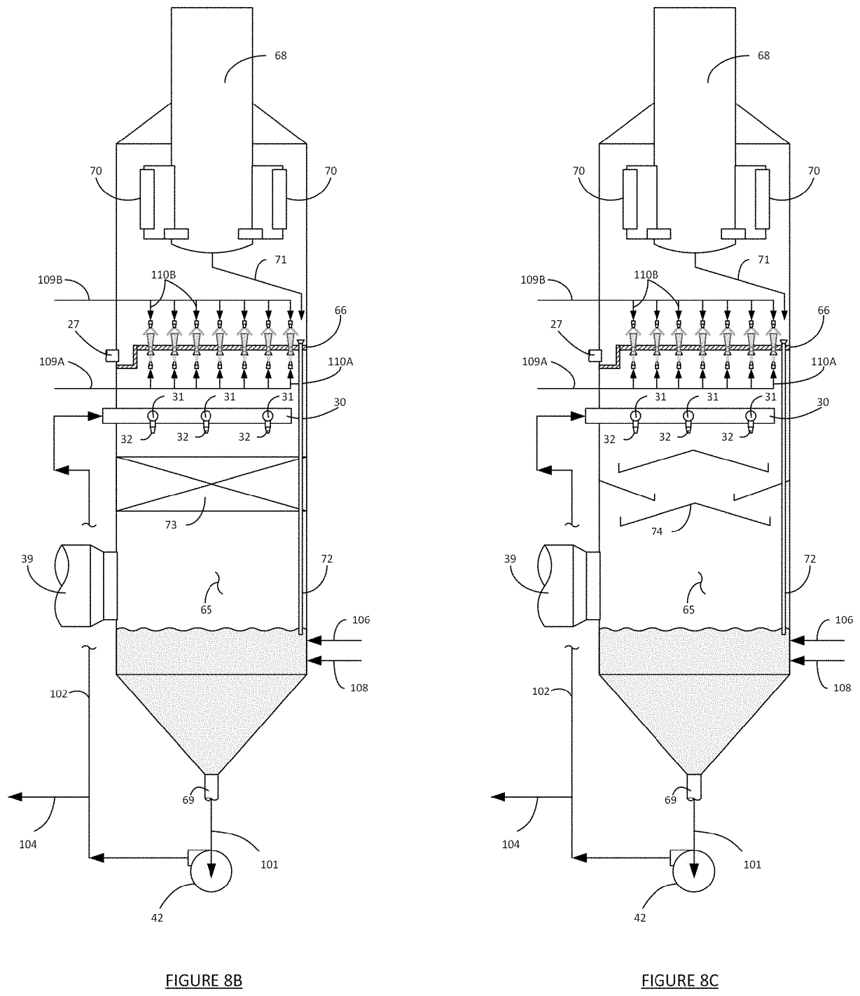

FIG. 8 depicts a conventional small ejector venturi which is installed inside a gas enclosure. The venturi consists of an inlet cone (80), a throat (81), a diverging section (82), a first liquid nozzle (84) creating a hollow spray pattern defined by a spray angle (86), and an optional second nozzle (83) creating a full liquid spray pattern defined by a spray angle (85). Gas to be treated enters the ejector venturi via inlet section (80) where gas velocity is rapidly increased. Liquid, from the second liquid nozzle (83), when provided, is completely mixed with the gas stream at the inlet of the throat (81). Treatment of the gas stream occurs in the throat (81) when an inlet liquid nozzle (83) is provided. The gas stream, when liquid nozzle (83) is not provided, or the two phase gas and liquid stream when liquid nozzle (83) is provided, then exits the ejector venturi via the diverging section (82) and pass through the spray (86) to effect primary or secondary gas treatment. Such gas treatment has limited effectiveness due to the very short contact time between the spray (86) formed by liquid droplets from the nozzle (84) and the gas.

FIG. 8A depicts a typical scrubbing system employing small ejector type venturis. In such a system, gas to be treated enters the enclosure (65) by a single gas inlet (39). First stage scrubbing is affected by contacting the gas with circulating liquid sprayed from one or more levels of liquid spray assemblies comprised of a main header, laterals (31) and spray nozzles (32). The outlet of the spray chamber then passes to the venturi scrubbing stage. The venturi scrubbing stage consists of a full draw tray fitted with multiple small venturi scrubbers (described in FIG. 8 and previous FIG. 8 write-up). Typical scrubber sizes used in this configuration are 12 inches to 24 inches in size. (Conventional scrubber gas inlet and outlet dimensions are normally the same and are the characteristic dimensions used to describe scrubber “size”). While larger scrubbers can be used in this configuration to reduce the overall number of scrubber assemblies required to provide the desired level of gas treatment, they require additional enclosure height to accommodate a longer venturi length significantly increasing the overall cost of the scrubbing system. The vertical orientation of the venturi scrubbers necessitates installation of liquid supply headers (109A) and individual nozzle supply laterals (110A) for venturi outlet contacting nozzles and liquid supply headers (109B) and individual nozzle supply laterals (110B) for venturi inlet spray nozzles inside the gas enclosure (65) making them inaccessible for maintenance or change out with the scrubbing system in service. Since liquid nozzle design and condition is critical to venturi scrubber performance, most ejector type venturis used to remove particulate matter from gas streams are fitted with expensive highly abrasion resistant liquid nozzles to reduce nozzle wear and allow the unit to maintain long term scrubbing performance, thereby extending the time between scrubber shutdowns for nozzle maintenance/replacement. The compact venturi scrubber (1A) described herein is specifically designed to allow fewer larger venturi scrubbers to be used in each venturi contacting stage, thereby providing external access to the liquid inlet (3) and nozzle (4) as well as liquid supply headers and individual liquid supply lines, allowing for on-stream inspection, maintenance, and replacement of these critical components. As a result, these components can be made of substantially less expensive materials. Conventional scrubbing systems configured with internal venturi scrubbers must shutdown to remedy a nozzle failure; scrubbing systems based on an embodiment of the present invention do not have this limitation. Conventional scrubbing systems configured with internal venturi scrubbers must shut down to change nozzle configuration to improve scrubbing performance. It should be noted that the shutdown of a scrubbing system is likely to also require the shutdown or rate reduction of the upstream process generating the gas which is treated in the scrubber, with attendant negative operations, safety and economic impacts. As noted above, an embodiment of the present invention is intended to avoid these consequences inherent in the design of conventional venturi scrubbing systems.

FIG. 8B depicts a conventional two stage venturi scrubbing system employing small ejector venturis in which the first liquid gas contacting stage employs conventional wetted packing or grid.

FIG. 8C depicts a conventional two stage venturi scrubbing system employing small ejector venturis in which the first liquid-gas contacting stage employs trays.

An embodiment of the present invention can be comprised of one or more scrubbing stages utilizing the compact venturi scrubber(s) described herein with or without any number of inter-stage gas treatment sections.

An embodiment of the present invention can be comprised of one or more scrubbing stages utilizing the compact venturi scrubber(s) described herein situated downstream of a conventional spray or tray tower contacting section.

An embodiment of the present invention can be used to retrofit existing scrubbing systems based on low energy contacting such as spray or tray towers, packed bed columns, and similar contacting methods. An embodiment of the present invention may entail placing one or more scrubbing stage(s) utilizing the compact venturi scrubber(s) described herein downstream of the existing scrubber and situated inside the existing scrubber enclosure, which enclosure might be a tower, column, duct, or similar structures.

An embodiment of the present invention can be used to replace existing low collection efficiency contacting stages of existing scrubbing systems to improve scrubbing performance, increase scrubber gas capacity, or to decrease scrubber energy demand. An embodiment of the present invention is well suited for acid gas, acid fume, and particulate removal from contaminated gas streams.

An embodiment of the present invention is well suited for gas phase reactor outlet combined quenching and contaminant removal applications. As an example, quenching, killing, or stopping the polymerization reaction catalyzed by ammonia in the outlet stream from an acrylonitrile reactor, cooling the resulting treated gas stream, and condensing some of the water contained in the inlet gas stream may be accomplished using an embodiment of the present invention. In this application sulfuric acid, added to an aqueous circulating liquid stream, reacts with absorbed ammonia forming soluble ammonium sulfate salt which is discharged from the system dissolved in the aqueous purge stream.

An embodiment of the present invention is well suited for adding the capability for removing carbon dioxide (CO2) from flue gases emanating from the combustion of hydrocarbon fuels (natural gas, produced gas, well head gas, liquid oil fuels, coke, carbon coal, wood, and biomass) and from process and vent gas streams emanating from a myriad of chemical, petrochemical, polymer, pharmaceutical, and metal manufacturing processes which may or may not already have treatment facilities. The small footprint of gas treatment systems utilizing the novel compact venturi scrubber can significantly reduce installation costs and the low pressure drop of such systems will in many cases eliminate the need for modifications to or replacement of existing upstream equipment, common when other types of scrubbing systems are employed.

An embodiment of the present invention is well suited for controlling the emissions of CO2 from cement, lime, limestone and other mineral processing and manufacturing operations. The low back pressure of a scrubbing system based on the novel compact venturi scrubber will in many cases eliminate the need for modifications to or replacement of existing upstream equipment, common when other types of wet scrubbing systems are employed. For new grass roots manufacturing and processing facilities, multi component control can be achieved in scrubbers based on the novel compact venturi, eliminating the need for separate emissions control systems saving capital cost, operating cost and plant plot space.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A compact venturi scrubber comprising:
a gas inlet section,
a discharge section aligned with the gas inlet section, the discharge section having (i) a base defined by the intersection of the gas inlet section and the discharge section, (ii) a diverging interior surface, and (iii) a diverging angle defined by the diverging interior surface,
a nozzle, and
a liquid inlet through which a liquid scrubbing medium is introduced to the nozzle,
wherein the nozzle produces a full spray pattern directed towards the base of the discharge section with a sufficiently large discharge angle so that the cross-sectional area of the full spray pattern produced by the nozzle at the point it intersects with the base of the discharge section fully covers, and substantially matches the size and shape of, the cross-sectional area of the base of the discharge section.

2. The compact venturi scrubber of claim 1, wherein the diverging angle of the discharge section and the discharge angle of the full spray pattern produced by the nozzle are substantially the same.

3. The compact venturi scrubber of claim 1, wherein the diverging angle of the discharge section and the discharge angle of the full spray pattern produced by the nozzle are substantially the same and are greater than 20 degrees.

4. The compact venturi scrubber of claim 1, wherein the diverging angle of the discharge section and the discharge angle of the full spray pattern produced by the nozzle are substantially the same and are between 20 and 45 degrees.

5. The compact venturi scrubber of claim 1, wherein the cross-sectional geometry of the full spray pattern, the cross-sectional geometry of the base of the discharge section, and the cross-sectional geometry of the discharge section are substantially the same.

6. The compact venturi scrubber of claim 5, wherein the cross-sectional geometries of the full spray pattern, the base of the discharge section, and the discharge section are substantially the same and are circular or rectangular.

7. The compact venturi scrubber of claim 5, further comprised of one or more additional nozzles.

8. The compact venturi scrubber of claim 1, wherein (i) the diverging angle of the discharge section and the discharge angle of the full spray pattern produced by the nozzle are substantially the same and are between 20 and 45 degrees and (ii) the cross-sectional geometry of the full spray pattern, the cross-sectional geometry of the base of the discharge section, and the cross-sectional geometry of the discharge section are substantially the same and are circular or rectangular.

9. A venturi scrubbing system comprising one or more scrubbing stages, each scrubbing stage having one or more compact venturi scrubbers, each compact venturi scrubber comprising:
a gas inlet section,
a discharge section aligned with the gas inlet section, the discharge section having (i) a base defined by the intersection of the gas inlet section and the discharge section, (ii) a diverging interior surface, and (iii) a diverging angle defined by the diverging interior surface,
a nozzle, and
a liquid inlet through which a liquid scrubbing medium is introduced to the nozzle,
wherein the nozzle produces a full spray pattern directed towards the base of the discharge section with a sufficiently large discharge angle so that the cross-sectional area of the full spray pattern produced by the nozzle at the point it intersects with the base of the discharge section fully covers, and substantially matches the size and shape of, the cross-sectional area of the base of the discharge section.

10. The venturi scrubbing system of claim 9, wherein the diverging angle of the discharge section and the discharge angle of the full spray pattern produced by the nozzle of one or more of the compact venturi scrubbers are substantially the same.

11. The venturi scrubbing system of claim 9, wherein the diverging angle of the discharge section and the discharge angle of the full spray pattern produced by the nozzle of one or more of the compact venturi scrubbers are substantially the same and are greater than 20 degrees.

12. The venturi scrubbing system of claim 9, wherein the diverging angle of the discharge section and the discharge angle of the full spray pattern produced by the nozzle of one or more of the compact venturi scrubbers are substantially the same and are between 20 and 45 degrees.

13. The venturi scrubbing system of claim 9, wherein the cross-sectional geometry of the full spray pattern, the cross-sectional geometry of the base of the discharge section, and the cross-sectional geometry of the discharge section of one or more of the compact venturi scrubbers are substantially the same.

14. The venturi scrubbing system of claim 13, wherein the cross-sectional geometries of the full spray pattern, the base of the discharge section, and the discharge section of one or more of the compact venturi scrubbers are substantially the same and are circular or rectangular.

15. The venturi scrubbing system of claim 14, wherein one or more of the compact venturi scrubbers is further comprised of one or more additional nozzles.

16. The venturi scrubbing system of claim 9, wherein the nozzle and liquid inlet of one or more of the compact venturi scrubbers are removeable and are situated within an isolation assembly, the isolation assembly being accessible from the exterior of the venturi scrubbing system and having a means for preventing the leakage of gas from within the venturi scrubbing system when the nozzle or liquid inlet is removed.

17. The venturi scrubbing system of claim 9 wherein the installation of one or more of the compact venturi scrubbers enables the orientation of the compact venturi scrubber to be changed.

18. The venturi scrubbing system of claim 9, wherein (i) the diverging angle of the discharge section and the discharge angle of the full spray pattern produced by the nozzle of one or more of the compact venturi scrubbers are substantially the same and are between 20 and 45 degrees, (ii) the cross-sectional geometry of the full spray pattern, the cross-sectional geometry of the base of the discharge section, and the cross-sectional geometry of the discharge section of one or more of the compact venturi scrubbers are substantially the same and are circular or rectangular, and (iii) the nozzle and the liquid inlet of one or more of the compact venturi scrubbers are removeable and are situated within an isolation assembly, the isolation assembly being accessible from the exterior of the venturi scrubbing system and having a means for preventing the leakage of gas from within the venturi scrubbing system when the nozzle or liquid inlet is removed.

19. A method for the removal of materials from a gas stream utilizing a compact venturi scrubber that comprises (a) a gas inlet section, (b) a discharge section aligned with the gas inlet section, the discharge section having (i) a base defined by the intersection of the gas inlet section and the discharge section, (ii) a diverging interior surface, and (iii) a diverging angle defined by the diverging interior surface, (c) a nozzle, and (d) a liquid inlet through which a liquid scrubbing medium is introduced to the nozzle, the method comprising:
producing, by the nozzle, a full spray pattern directed towards the base of the discharge section with a sufficiently large discharge angle so that the cross-sectional area of the full spray pattern produced by the nozzle at the point it intersects with the base of the discharge section fully covers, and substantially matches the size and shape of, the cross-sectional area of the base of the discharge section, and
passing the gas stream through the gas inlet section and discharge section of the compact venturi scrubber as it mixes with the liquid scrubbing medium.

20. The method of claim 19, wherein (i) the diverging angle of the discharge section and the discharge angle of the full spray pattern produced by the nozzle of the compact venturi scrubber are substantially the same and are between 20 and 45 degrees and (ii) the cross-sectional geometry of the full spray pattern, the cross-sectional geometry of the base of the discharge section, and the cross-sectional geometry of the discharge section of the compact venturi scrubber are substantially the same and are circular or rectangular.
